(19) United States
(12) Patent Application Publication
(10) Pub. No.: US 2014/0146349 A1
(43) Pub. Date: May 29, 2014

(54) PRINTER INCLUDING WIRELESS ROUTING CAPABILITY

(71) Applicant: Richard A. Murray, San Diego, CA (US)

(72) Inventor: Richard A. Murray, San Diego, CA (US)

(21) Appl. No.: 13/687,398

(22) Filed: Nov. 28, 2012

(51) Int. Cl. G06F 3/12

(52) U.S. Cl. CPC G06F 3/1293
USPC 358/1.15

(57) ABSTRACT

A printer is configured to provide local network access for at least one other local electronic device. The printer includes a printing apparatus for printing on a recording medium; a media advance system for moving the recording medium into position to be printed on by the printing apparatus; a port for connection to an external modem; a wireless communication device; and a controller including router firmware for wirelessly directing and routing data for the at least one other local electronic device between computer networks.

### FIELD OF THE INVENTION

The present invention relates generally to a multifunction printer having wireless communication capability, and more particularly to a multifunction printer that provides wireless network access for other local electronic devices.

### BACKGROUND OF THE INVENTION

A recent trend in multifunction printers is to incorporate wireless communication capability, such that electronic devices such as laptop computers, smart phones or tablets can wirelessly send print jobs to such a multifunction printer. For example, a multifunction printer can include a Wi-Fi module and associated firmware to permit it to receive image data for printing using radio waves over a wireless local area network

A typical local area network includes a router that is connected to a cable modem or a DSL modem. A router is a device that forwards data packets between computer networks. A router is connected to two or more data lines from different networks. When a data packet comes in one of the lines, the router reads the address information in the packet to determine its ultimate destination. Then, using information in its routing table or routing policy, it directs the packet to the next network on its journey. Routers perform the traffic directing functions on the Internet. A data packet is typically forwarded from one router to another through the networks that constitute the internetwork until it gets to its destination. A router having wireless capability typically is connected to the cable modem or DSL modem by cable, but can be connected to other devices on the local area network by cable or by wireless connection. The router is generally provided as a box that is separate from the modem, thereby taking up additional space.

What is needed is a way to provide local network access for network connectable electronic devices without requiring a separate router, while also providing easy network access for a multifunction printer.

### SUMMARY OF THE INVENTION

A printer configured to provide local network access for at least one other local electronic device, the printer comprises: a printing apparatus for printing on a recording medium; a media advance system for moving the recording medium into position to be printed on by the printing apparatus; a port for connection to an external modem; a wireless communication device; and a controller including router firmware for wirelessly directing and routing data for the at least one other local electronic device between computer networks.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a schematic representation of an inkjet printer system;

FIG. 2 is a perspective of a portion of a printhead;

FIG. 3 is a perspective of a portion of a carriage printer;

FIG. 4 is a schematic side view of an exemplary paper path in a carriage printer;

FIG. 5 is a perspective of a multifunction printing system;

FIG. 6 is a block diagram of a prior art local area network having both cable connection and wireless connection between a wireless router and a variety of local electronic devices; and

FIG. 7 is a block diagram of a local area network having a router incorporated within a multifunction printer according to an embodiment of the invention.

### DETAILED DESCRIPTION OF THE INVENTION

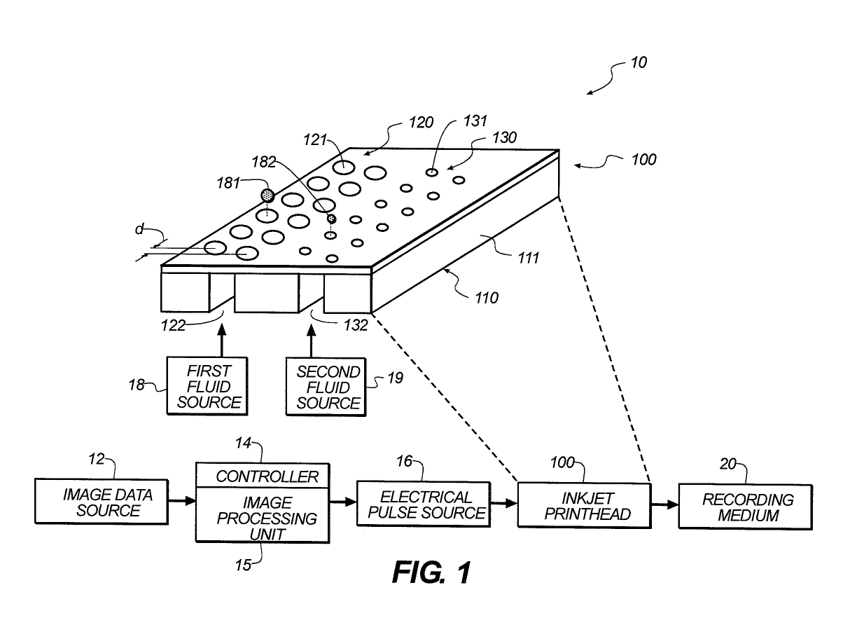

Referring to FIG. 1, a schematic representation of an inkjet printer system 10 is shown, for its usefulness with the present invention and is fully described in U.S. Pat. No. 7,350,902, and is incorporated by reference herein in its entirety. The inkjet printer system 10 includes an image data source 12, which provides data signals that are interpreted by a controller 14 as being commands to eject drops. The controller 14 includes an image processing unit 15 for rendering images for printing, and outputs signals to an electrical pulse source 16 of electrical energy pulses that are inputted to an inkjet printhead 100, which includes at least one inkjet printhead die 110.

In the example shown in FIG. 1, there are two nozzle arrays 120, 130. Nozzles 121 in the first nozzle array 120 have a larger opening area than nozzles 131 in the second nozzle array 130. In this example, each of the two nozzle arrays 120, 130 has two staggered rows of nozzles 121, 131, each row having a nozzle density of 600 per inch. The effective nozzle density then in each nozzle array 120, 130 is 1200 per inch (i.e. d= 1/1200 inch in FIG. 1). If pixels on a recording medium 20 were sequentially numbered along the paper advance direction, the nozzles 121, 131 from one row of the nozzle arrays 120, 130 would print the odd numbered pixels, while the nozzles 121, 131 from the other row of the nozzle arrays 120, 130 would print the even numbered pixels.

In fluid communication with each nozzle array 120, 130 is a corresponding ink delivery pathway 122, 132. The ink delivery pathway 122 is in fluid communication with the first nozzle array 120, and the ink delivery pathway 132 is in fluid communication with the second nozzle array 130. Portions of the ink delivery pathways 122 and 132 are shown in FIG. 1 as openings through a printhead die substrate 111. One or more inkjet printhead die 110 will be included in the inkjet printhead 100, but for greater clarity only one inkjet printhead die 110 is shown in FIG. 1. In FIG. 1, a first fluid source 18 supplies ink to the first nozzle array 120 via the ink delivery pathway 122, and a second fluid source 19 supplies ink to the second nozzle array 130 via the ink delivery pathway 132. Although distinct first and second fluid sources 18 and 19 are shown, in some applications it can be beneficial to have a single fluid source supplying ink to both the first nozzle array 120 and the second nozzle array 130 via the ink delivery pathways 122 and 132 respectively. Also, in some embodiments, fewer than two or more than two nozzle arrays 120, 130 can be included on printhead die 110. In some embodiments, all nozzles 121, 131 on the inkjet printhead die 110 can be the same size, rather than having multiple sized nozzles 121, 131 on the inkjet printhead die 110.

Drop forming mechanisms associated with the nozzles 121, 131 are not shown in FIG. 1. The drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from the electrical pulse source 16 are sent to the various drop ejectors according to the desired deposition pattern. In the example of FIG. 1, droplets 181 ejected from the first nozzle array 120 are larger than droplets 182 ejected from the second nozzle array 130, due to the larger nozzle opening area. Typically other aspects of the drop forming mechanisms (not shown) associated respectively with the first and second nozzle arrays 120 and 130 are also sized differently in order to optimize the drop ejection process for the different sized drops. During operation, droplets 181, 182 of ink are deposited on the recording medium 20.

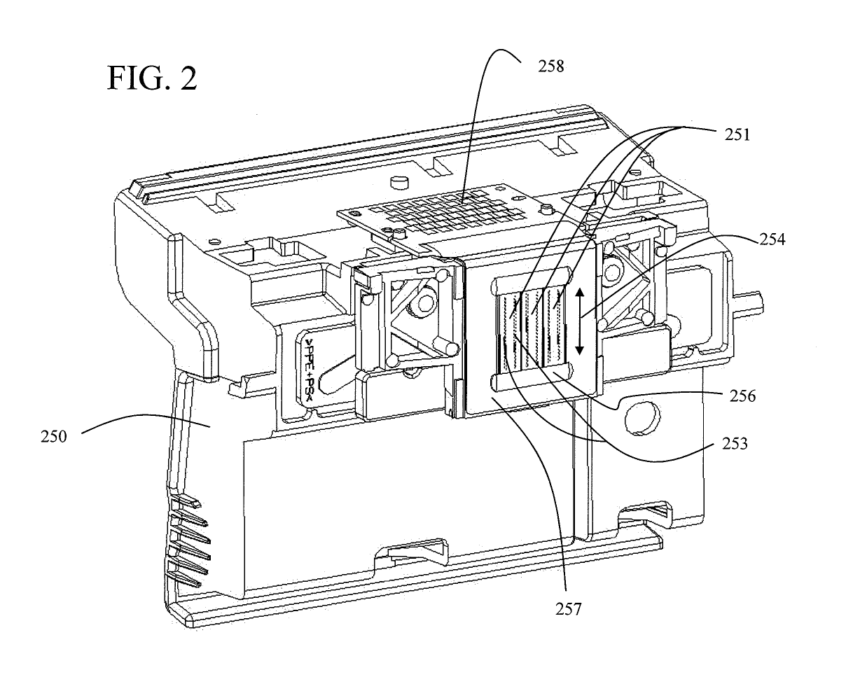

FIG. 2 shows a perspective of a portion of a printhead 250, which is an example of the inkjet printhead 100. The printhead 250 includes three printhead die 251 (similar to printhead die 110 in FIG. 1), each printhead die 251 containing two nozzle arrays 253, so that the printhead 250 contains six nozzle arrays 253 altogether. The six nozzle arrays 253 in this example can each be connected to separate ink sources (not shown in FIG. 2); such as cyan, magenta, yellow, text black, photo black, and a colorless protective printing fluid. Each of the six nozzle arrays 253 is disposed along a nozzle array direction 254, and the length of each nozzle array 253 along the nozzle array direction 254 is typically on the order of 1 inch or less. Typical lengths of the recording medium 20 are 6 inches for photographic prints (4 inches by 6 inches) or 11 inches for paper (8.5 by 11 inches). Thus, in order to print a full image, a number of swaths are successively printed while moving the printhead 250 across the recording medium 20. Following the printing of a swath, the recording medium 20 is advanced along a media advance direction 304 that is substantially parallel to the nozzle array direction 254.

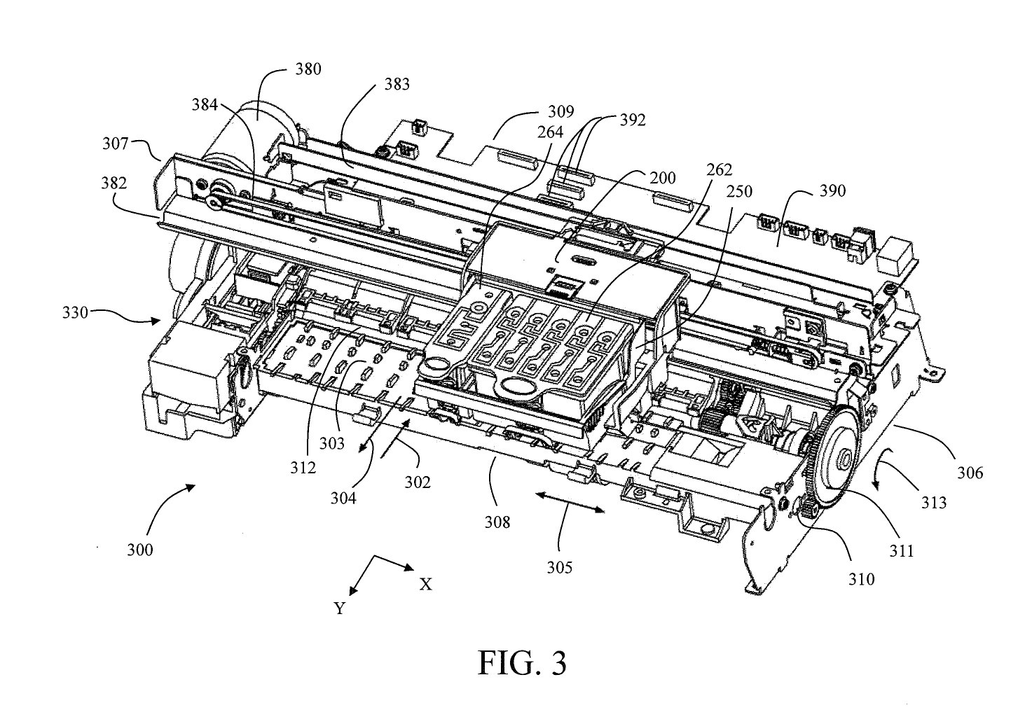

Also shown in FIG. 2 is a flex circuit 257 to which the printhead die 251 are electrically interconnected, for example, by wire bonding or TAB bonding. The interconnections are covered by an encapsulant 256 to protect them. The flex circuit 257 bends around the side of the printhead 250 and connects to a connector board 258. When the printhead 250 is mounted into a carriage 200 (see FIG. 3), the connector board 258 is electrically connected to a connector (not shown) on the carriage 200 so that electrical signals can be transmitted to the printhead die 251.

FIG. 3 shows a portion of a desktop carriage printer. Some of the parts of the printer have been hidden in the view shown in FIG. 3 so that other parts can be more clearly seen. A printing mechanism 300 has a print region 303 across which the carriage 200 is moved back and forth in a carriage scan direction 305 along the X axis, between a right side 306 and a left side 307 of the printing mechanism 300, while drops are ejected from the printhead die 251 (not shown in FIG. 3) on the printhead 250 that is mounted on the carriage 200. A carriage motor 380 moves a belt 384 to move the carriage 200 along a carriage guide rail 382. An encoder sensor (not shown) is mounted on the carriage 200 and indicates carriage location relative to an encoder fence 383.

The printhead 250 is mounted in the carriage 200, and a multi-chamber ink supply 262 and a single-chamber ink supply 264 are mounted in the printhead 250. The mounting orientation of the printhead 250 is rotated relative to the view in FIG. 2 so that the printhead die 251 are located at the bottom side of the printhead 250; the droplets 181, 182 of ink are ejected downward onto the recording medium 20 in the print region 303 in the view of FIG. 3. The multi-chamber ink supply 262, in this example, contains five ink sources: cyan, magenta, yellow, photo black, and colorless protective fluid; while the single-chamber ink supply 264 contains the ink source for text black. Paper or other recording medium 20 (sometimes generically referred to as paper or media herein) is loaded along a paper load entry direction 302 toward the front of the printing mechanism 308.

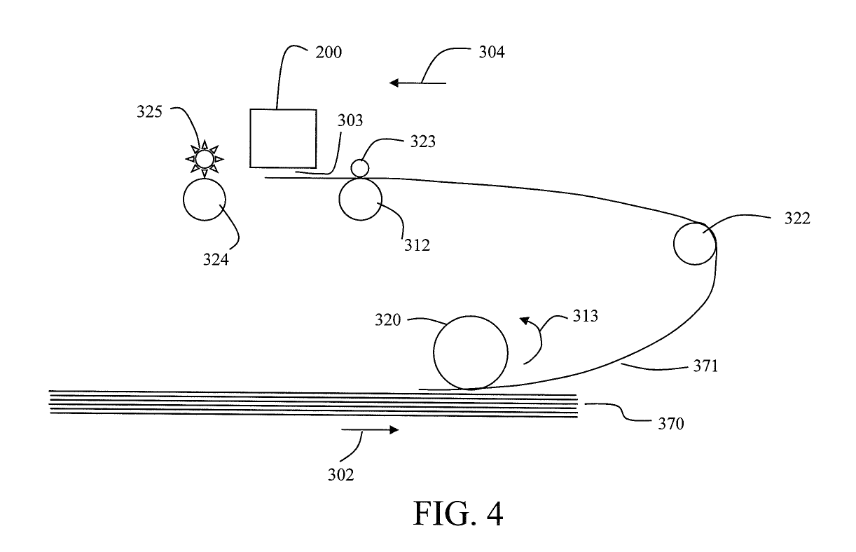

A variety of rollers are used to advance the recording medium 20 through the printer as shown schematically in the side view of FIG. 4. In this example, a pick-up roller 320 moves a top piece or sheet 371 of a stack 370 of paper or other recording medium 20 in the direction of arrow, a paper load entry direction 302. A turn roller 322 acts to move the paper around a C-shaped path (in cooperation with a curved rear wall surface) so that the paper continues to advance along the media advance direction 304 from a rear 309 of the printing mechanism (with reference also to FIG. 3). The paper is then moved by a feed roller 312 and idler roller(s) 323 to advance along the Y axis across the print region 303, and from there to a discharge roller 324 and star wheel(s) 325 so that printed paper exits along the media advance direction 304 to a media output holder (not shown). The feed roller 312 includes a feed roller shaft along its axis, and a feed roller gear 311 is mounted on the feed roller shaft. The feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller 312.

The motor that powers the paper advance rollers is not shown in FIG. 3, but a hole 310 at the right side 306 of the printing mechanism 300 is where the motor gear (not shown) protrudes through in order to engage the feed roller gear 311, as well as the gear for the discharge roller (not shown). For normal paper pick-up and feeding, it is desired that all rollers rotate in forward rotation direction 313. Toward the left side 307 of the printing mechanism 300, in the example of FIG. 3, is a maintenance station 330.

Toward the rear 309 of the printing mechanism 300, in this example, is located an electronics board 390, which includes cable connectors 392 for communicating via cables (not shown) to the printhead carriage 200 and from there to the printhead 250. Also on the electronics board 390 are typically mounted motor controllers for the carriage motor 380 and for the paper advance motor, a clock for measuring elapsed time, a processor and other control electronics (shown schematically as the controller 14 and the image processing unit 15 in FIG. 1) for controlling the printing process, and an optional connector for a cable to a host computer.

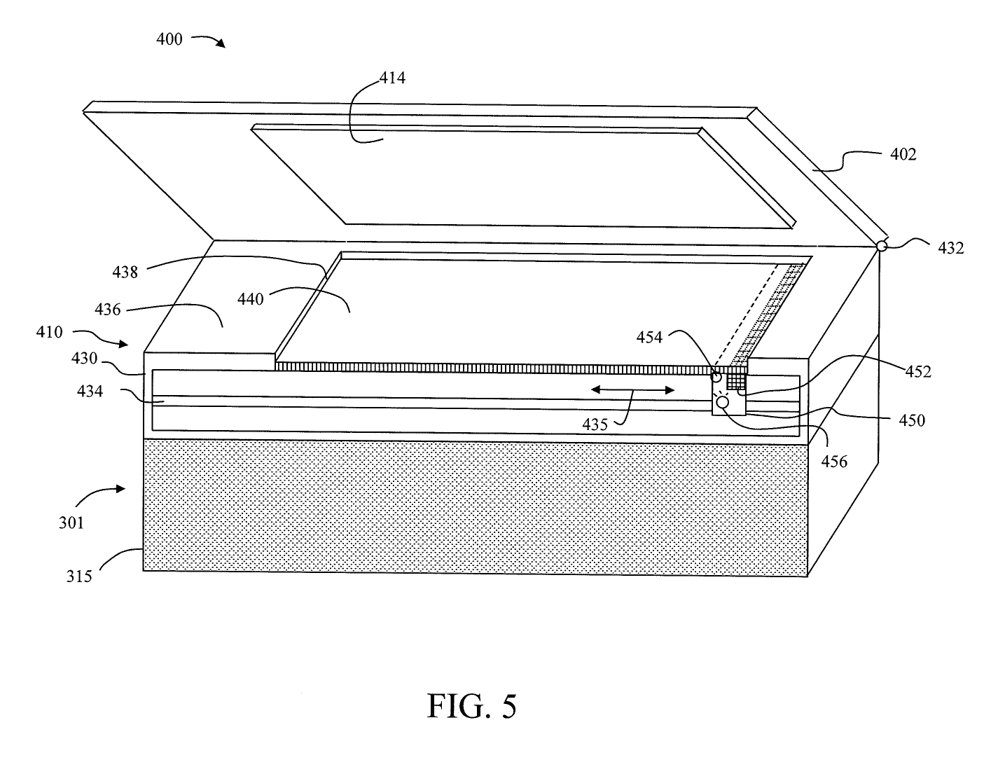

FIG. 5 shows a perspective of a multifunction printer 400 having a printing apparatus 301 including a printing mechanism for printing images, such as printing mechanism 300 (FIG. 3), enclosed within a housing 315, and also a scanning apparatus 410 for scanning documents or other items. In this view, the front portion of the scanning apparatus 410 is cut away in order to show internal features of the scanning apparatus 410 more clearly. The multifunction printer 400 can do printing, scanning of documents, or copying of documents (i.e. printing plus scanning).

The scanning apparatus 410 includes a scanning apparatus body 430 and a lid 402, which is pivotably attached to the scanning apparatus body 430 by a hinge 432. The surface of the scanning apparatus body 430 that is covered by the lid 402 when the lid 402 is closed includes a frame 436. A transparent platen 440 (typically a flat piece of glass) is inset within the frame 436. In the example shown in FIG. 5, the surface of the transparent platen 440 is lower than the surface of the frame 436 so that there is an offset 438. The transparent platen 440 is not covered by the lid 402 when the lid 402 is open as it is in FIG. 5.

Below the transparent platen 440 is a movable sensor array module 450. In the example shown in FIG. 5, the sensor array module 450 includes a photosensor array (such as a contact image sensor) 452 extending the width of the transparent platen 440, a roller 454 that is biased into contact with an underside of the transparent platen 440, and a light source 456 that illuminates a scan line of a document or other item (not shown) that is placed on top of transparent platen 440. A light guide and other optics (not shown) can also be included in sensor array module 450. The sensor array module 450 is moved back and forth along a scanning guide 434 in a scanning direction 435 across the length of the transparent platen 440 in order to scan the document or other item, receiving reflected light from the item through the transparent platen 440 scan line by scan line and converting the reflected light into electrical signals. The controller 14 converts the electrical signals into digitized data to form a digitized image of the item. The scanning guide 434 can be a round rail, a rack and pinion or other guiding member that can use the power of a motor (not shown) to provide a linear motion along the scanning direction 435.

In the example shown in FIG. 5, the lid 402 includes a reflective backing plate 414. The thickness of the reflective backing plate 414 is accommodated in the offset 438 between the frame 436 and the top surface of the transparent platen 440 when the scanner lid 402 is closed. The reflective backing plate 414 can be resiliently mounted on the lid 402, so that the reflective backing plate 414 is effective in pressing documents of various thicknesses against the transparent platen 440. Typically the reflective backing plate 414 is white in the document scanning region. In some scanning apparatus configurations (not shown), the reflective backing function is integrated into the lid 402

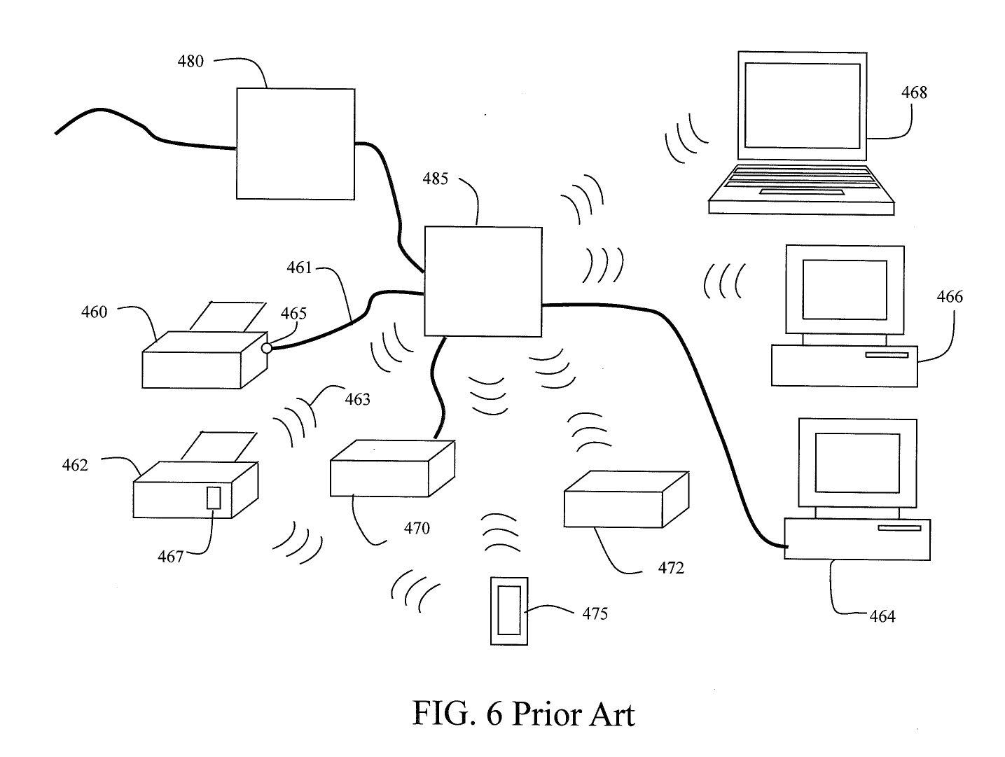

FIG. 6 shows a block diagram of a prior art local area network having both a cable connection and a wireless connection between a wireless router 485 and a variety of local electronic devices including a cable connected multifunction printer 460, a wireless connected multifunction printer 462, a cable connected computer 464, a wireless connected computer 466, a wireless connected laptop computer 468, a cable connected video game console 470, a wireless connected video game console 472 and a smart mobile device 475. The term “smart mobile device” as used herein, is meant to include, but not limited to, devices such as smart phones, tablets and other such wireless communication devices. Typical attributes of smart mobile devices are that they are wirelessly networkable (for example by Wi-Fi, 3G, 4G or the like), capable of voice communication, have a built-in camera, and capable of browsing the Internet. The cable connection is indicated by a cable 461 (typically an Ethernet or USB cable). The cable 461 is connected to a cable connection port 465 (shown for example on the cable connected multifunction printer 460). The wireless connection is indicated by radio waves 463, and two-way wireless communication between the local electronic device and the wireless router 485 is shown in FIG. 6. The wireless communication with the wireless connected multifunction printer 462 is done through a Wi-Fi module 467. The wireless router 485 is connected by Ethernet cable or USB cable to an external modem 480, such as a cable modem or a DSL modem. The wireless router 485 provides a wireless access point that connects the various wireless local electronic devices to a nearby wired local area network. The wireless router 485 typically includes an Ethernet switch and an internal router firmware application that provides Internet Protocol routing, network address translation, and domain name system forwarding via an external modem 480.

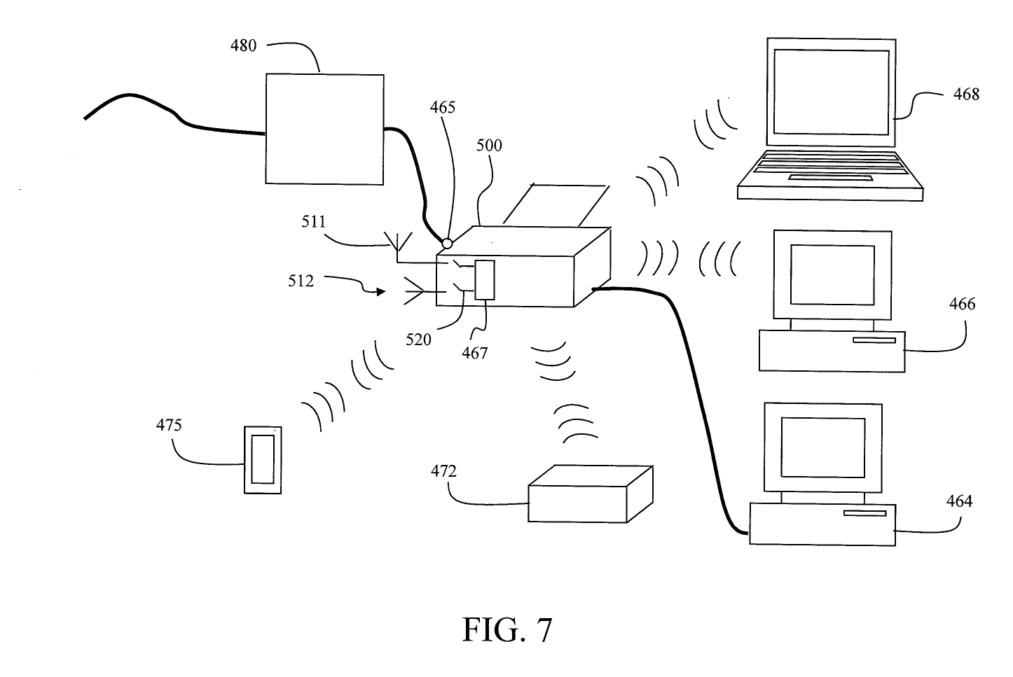

FIG. 7 shows a block diagram of an embodiment of the present invention. Comparing the prior art configuration shown in FIG. 6 to the FIG. 7 embodiment, it can be seen that the cable connection port 465 and the wireless communication device such as Wi-Fi module 467 of a multifunction printer 500 have been repurposed to form separate communication ports for a stand-alone printer. By connecting the cable connection port 465 (such as an Ethernet port) through new router firmware in the multifunction printer 500, the cable connection port 465 is enabled to function as a direct connection port to the external cable modem 480. By providing a routing algorithm directing data and traffic through the Wi-Fi module 467, the multifunction printer 500 is configured to provide routing capability and local network access for at least one other electronic device. The controller 14 (FIG. 1) includes the router firmware for wirelessly directing and routing data for the at least one other local electronic device between computer networks. The multifunction printer 500 typically includes a plurality of cable connections so that cable connected devices such as the cable connected computer 464 can be networked through the multifunction printer 500. However, it is particularly advantageous when the router firmware is configured to transfer data between the controller 14 and the at least one other electronic device via wireless communication, as is indicated in FIG. 7. The router firmware is also configured to transfer data between the controller and networks beyond the local area via the external cable modem 480.

Wi-Fi communication, according to IEEE 802.11 standards, uses a plurality of channels in a band of frequencies around 2.4 GHz or 5 GHz. It can be advantageous for the multifunction printer 500 to have a first antenna 511 and a second antenna 512 that are connectable to the wireless communication device, such as Wi-Fi module 467. The first antenna 511 can be configured to receive a first frequency, and the second antenna 512 can be configured to receive a second frequency. In addition or alternatively, for more robust transmission and reception between Wi-Fi module 467 and the variously located wireless-connected local electronic devices for which multifunction printer 500 provides routing, it can be advantageous if the first antenna 511 has a first orientation and the second antenna 512 has a second orientation, as shown in FIG. 7. A switch 520 can be provided to controllably and selectively permit connection of the first antenna 511 or the second antenna 512 to the Wi-Fi module 467. In some embodiments, the switch 520 is programmable.

A wireless access point that provides local network access for at least one other local networkable electronic device is sometimes called a hotspot. It can be said that the multifunction printer 500 has a connection to the Internet through a cable-tethered Ethernet connection, and is configured to provide and maintain a hotspot for wireless communication for at least one local networkable device. Such local networkable devices can include a computer or a mobile device such as a smart phone or a tablet. In addition to providing local network access to at least one other networkable device without an additional router, an added benefit for the multifunction printer 500 is that there is no need to configure it to connect to a wireless router, since the printer already includes a router with connection to the cable modem.

The present invention has been described in detail with particular reference to certain preferred embodiments thereof, but it will be understood that variations and modifications can be effected within the spirit and scope of the invention. For example, embodiments employing inkjet printheads as printing devices have been described. The invention is also applicable to printing systems having different types of printheads, or printing devices including a laser for making marks on the recording medium.

### PARTS LIST

10 Inkjet printer system
12 Image data source
14 Controller
15 Image processing unit
16 Electrical pulse source
18 First fluid source
19 Second fluid source
20 Recording medium
100 Inkjet printhead
110 Inkjet printhead die
111 Substrate
120 First nozzle array
121 Nozzle(s)
122 Ink delivery pathway (for first nozzle array)
130 Second nozzle array
131 Nozzle(s)
132 Ink delivery pathway (for second nozzle array)
181 Droplet(s) (ejected from first nozzle array)
182 Droplet(s) (ejected from second nozzle array)
200 Carriage
250 Printhead
251 Printhead die
253 Nozzle array
254 Nozzle array direction
256 Encapsulant
257 Flex circuit
258 Connector board
262 Multi-chamber ink supply
264 Single-chamber ink supply
300 Printing mechanism
301 Printing apparatus
302 Paper load entry direction
303 Print region
304 Media advance direction
305 Carriage scan direction
306 Right side of printing mechanism
307 Left side of printing mechanism
308 Front of printing mechanism
309 Rear of printing mechanism
310 Hole (for paper advance motor drive gear)
311 Feed roller gear
312 Feed roller
313 Forward rotation direction (of feed roller)
315 Housing
320 Pick-up roller
322 Turn roller
323 Idler roller
324 Discharge roller
325 Star wheel(s)
330 Maintenance station
370 Stack of media
371 Sheet
380 Carriage motor
382 Carriage guide rail
383 Encoder fence
384 Belt
390 Printer electronics board
392 Cable connectors
400 Multifunction printer
402 Lid
410 Scanning apparatus
414 Reflective backing plate
430 Body (of scanning apparatus)
432 Hinge
434 Scanning guide
435 Scanning direction
436 Frame
438 Offset
440 Transparent platen
450 Sensor array module
452 Photosensor array
454 Roller
456 Light source
460 Cable connected multifunction printer
461 Cable
462 Wireless connected multifunction printer
463 Radio waves
464 Cable connected computer
465 Cable connection port
466 Wireless connected computer
467 Wi-Fi module
468 Laptop computer
470 Cable connected video game console
472 Wireless connected video game console
475 Smart mobile device
480 External modem
485 Wireless router
500 Multifunction printer (with routing capability)
511 First antenna
512 Second antenna
520 Switch

1. A printer configured, to provide local network access for at least one other local electronic device, the printer comprising:
a printing apparatus for printing on a recording medium;
a media advance system for moving the recording medium into position to be printed on by the printing apparatus;
a port for connection to an external modem;
a wireless communication device; and
a controller including router firmware for wirelessly directing and routing data for the at least one other local electronic device between computer networks.

2. The printer of claim 1, wherein the router firmware is configured to transfer data between the controller and the at least one other local electronic device via wireless communication.

3. The printer of claim 1, wherein the router firmware is configured to transfer data between the controller and networks beyond the local area via the external cable modem.

4. The printer of claim 1 further comprising a first antenna and a second antenna that are connectable to the wireless communication device.

5. The printer of claim 4, wherein the first antenna is configured to receive a first frequency and the second antenna is configured to receive a second frequency.

6. The printer of claim 4, wherein the first antenna has a first orientation and the second antenna has a second orientation different from the first orientation.

7. The printer of claim 4 further comprising a switch to controllably permit connection of the first antenna or the second antenna to the wireless communication device.

8. The printer of claim 7, wherein the switch is programmable.

9. The printer of claim 1, wherein the wireless communication device includes a Wi-Fi module.

10. The printer of claim 1, wherein the external modem is a cable modem.

11. A printer having a connection to the Internet through a cable-tethered Ethernet connection, wherein the printer is configured to provide and maintain a hotspot for wireless communication for at least one local networkable device.

12. The printer of claim 11, wherein the at least one local networkable device includes a smart phone.

13. The printer of claim 11, wherein the at least one local networkable device includes a tablet.

14. The printer of claim 11, wherein the at least one local networkable device includes a computer.

15. The printer of claim 11, wherein the at least one local networkable device includes a mobile device.
